(19) United States
(12) Patent Application Publication
(10) Pub. No.: US 2011/0138403 A1
(43) Pub. Date: Jun. 9, 2011

(54) PUSH-BASED APPLICATION PROGRAM INTERFACE BASED ON DUALS OF A PULL-BASED APPLICATION PROGRAM INTERFACE

(75) Inventors: Henricus Johannes Maria Meijer, Mercer Island, WA (US); John Wesley Dyer, Monroe, WA (US); Dragos A. Manolescu, Kirkland, WA (US)

(73) Assignee: MICROSOFT CORPORATION, Redmond, WA (US)

(21) Appl. No.: 12/633,160

(22) Filed: Dec. 8, 2009

(51) Int. Cl. G06F 9/44

(52) U.S. Cl. 719/328

(57) ABSTRACT

Methods and devices are provided for defining push-based standard sequence operators based on respective duals of corresponding pull-based standard sequence operators. A push-based application program interface (API) may be defined based on mathematical duals of a corresponding pull-based API. The push-based API may include a library of routines, which further may include push-based standard sequence operators defined based on deriving mathematical duals of corresponding pull-based standard sequence operators. A protocol for processing a push-based collection may be defined as a mathematical dual of a protocol for processing a pull-based collection. In various embodiments, mathematical duality with respect to synchronous, pull-based, collections may be exploited to define operators for processing asynchronous push-based collections.

### BACKGROUND

Synchronous programming is straightforward. When a call to a function is made, a calling thread is blocked and waits until the function is completed before been unblocked. However, asynchronous programming is much more difficult for software developers than synchronous programming. In asynchronous programming, a thread that initiates an asynchronous call to a function is not blocked and can perform other processing before the function has completed. Thus, asynchronous programming allows parallel processing, but can introduce several complications.

As an example of some of the complications that can occur in asynchronous message passing, a method call initiated by a caller process may not be delivered to a callee object. Because the caller process does not wait for the message to be delivered to the callee object, the caller process will not be notified of an error concerning delivery of the message. Either operating systems provide an infrastructure for reporting such errors, or software developers write code to anticipate and handle such errors.

As another example of some of the complications that can occur in asynchronous programming, if a caller process does not wait for completion of a called function, how will the caller process learn of the completion of the call function? One solution is for a caller application to create a callback method, a polling mechanism, or an event trigger through which the caller application can be notified of the completion of the call function. However, this further complicates coding when compared with straightforward synchronous programming.

Currently, programming languages and libraries provide support for synchronous and pull-based programming, but provide very little support for asynchronous and event-based programming. Due to this and difficulties software developers have with asynchronous and event-based programming, software developers often break their computer code into a number of disjoint event-handlers and use an explicit continuation passing style. The lack of a simple programming model for asynchronous and event-based programming has become problematic for software developers due to the introduction of many-core computers, distributed computing and cloud computing.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A mathematical dual can be derived by replacing each occurrence of a domain in an operation with a codomain, and replacing each occurrence of g∘f=h with f∘g=h. In various embodiments consistent with the subject matter of this disclosure, a method and a computing device are provided for defining a push-based application program interface based on deriving a duals of aspects of a pull-based application program interface.

In some embodiments, a method and a computing device are provided for defining push-based standard sequence operators based on respective duals of corresponding pull-based standard sequence operators. In various embodiments, a protocol for a push-based collection is defined as a dual of a protocol for a pull-based collection.

Other features of the claimed subject matter are described in more detail below.

### DRAWINGS

In order to describe the manner in which the above-recited and other advantages and features can be obtained, a more particular description is described below and will be rendered by reference to specific embodiments thereof which are illustrated in the appended drawings. Understand that these drawings depict only typical embodiments and are not therefore to be considered to be limiting of its scope. Implementations will be described and explained with additional specificity and detail through the use of the accompanying drawings.

FIG. 1 is a block diagram of an exemplary processing device, which may be used to implement embodiments consistent with subject matter of this disclosure.

FIG. 2 illustrates exemplary iterator design patterns for enumerable (pull-based) collections and observable (push-based) collections.

FIG. 3 illustrates an exemplary optimized interface for processing push-based collections.

FIG. 4 shows that operators for push-based collections may introduce concurrency.

FIG. 5 illustrates duality and application of a select operator to pull-based and push-based collections.

FIG. 6 provides an example of exemplary code for implementing a Select sequence operator for pull-based collections.

FIG. 7 provides an example of exemplary code for implementing a Select sequence operator for push-based collections.

FIG. 8 lists exemplary standard sequence operators for push-based observable collections.

FIG. 9 illustrates operation of an exemplary Flatten sequence operator for push-based observable collections.

### OVERVIEW

In embodiments consistent with the subject matter of this disclosure, methods and computing devices are disclosed, such that a push-based application program interface (API) may be defined based on deriving mathematical duals of a corresponding pull-based application program interface (API). The push-based API may include a library of methods, or routines, which may further include push-based standard sequence operators defined by deriving duals of corresponding pull-based standard sequence operators.

In category theory, duality is observed when a first statement regarding a category C is true, the first statement regarding a dual D of the category C is true, a second statement regarding the category C is false, and the second statement regarding the dual D is also false. Suppose Σ is any statement of an elementary theory of an abstract category. The dual of Σ can be performed by:
replacing each occurrence of a “domain” in Σ with a “codomain”, and conversely,
replacing each occurrence of g∘f=h with f∘g=h.
   In other words, the dual of a statement may be formed by reversing arrows and compositions.

One example of duality is De Morgan's law, which exploits the duality between conjunction “&&” and disjunction “∥” to prove that negation “!” distributes over both conjunction and disjunction, as illustrated below:

!(a&&b)==!a∥!b

!(a∥b)==!a&&!b

Embodiments consistent with the subject matter of this disclosure exploit mathematical duality with respect to asynchronous, push-based collections and synchronous, pull-based collections, as will be discussed in more detail below.

### Exemplary Processing Devices

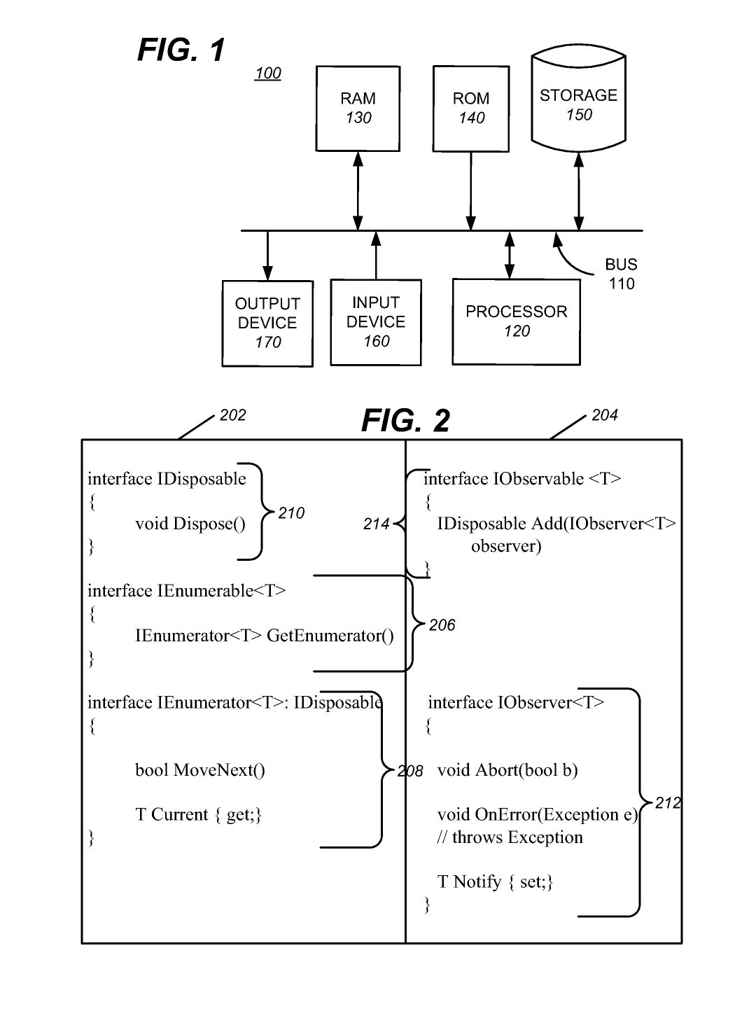

FIG. 1 is a block diagram of an exemplary computing device 100, which may be used to implement embodiments consistent with the subject matter of this disclosure. The computing device 100 may be a personal computer (PC), a handheld computing device, or another type of computing device. Computing device 100 may include hardware, such as at least one processor 120, a system bus 110, a memory, which may include a combination of random access memory (RAM) 130 and read only memory (ROM) 140, a storage device 150, an input device 160 and an output device 170.

Processor 120 may include one or more conventional processors that interpret and execute instructions. RAM 130, ROM 140, and/or another type of dynamic or static storage device may store information and instructions for execution by processor 120. RAM 130, or another type of dynamic storage device, may store instructions as well as temporary variables or other intermediate information used during execution of instructions by processor 120. ROM 140, or another type of static storage device, may store static information and instructions for processor 120.

Input device 150 may include a keyboard, a pointing device, or other device for providing input. Output device 160 may include a display, a printer, or other device for outputting information.

Storage device 150 may include a magnetic disk, a writable optical disc, a flash RAM device, or other type of storage device for storing data, instructions, or other information. Non-limiting examples of storage device 150 may include Digital Video Disk (DVD), Compact Disk (CD), or other types of storage devices.

Computing device 100 may communicate with other devices via a network and may perform functions in response to processor 120 executing sequences of instructions contained in a tangible machine-readable medium, such as, for example, RAM 130, ROM 140, optical disk, flash RAM, or other medium. Such instructions may be read into RAM 130 from another tangible machine-readable medium or from a separate device via a communication interface (not shown).

### Iterator Design Pattern

One embodiment consistent with the subject matter of this disclosure uses Language Integrated Query (LINQ), which is a component of Microsoft Corporation's .NET framework. LINQ defines query operators for querying, projecting, and filtering data in enumerable (pull-based) classes, arrays, relational databases, eXtensible Markup Language (XML), and other data sources. FIG. 2 illustrates APIs and a well-known exemplary iterator design pattern 202 for enumerable (pull-based) collections, and APIs and an exemplary iterator (or subject/observer) design pattern 204 for observable (push-based) collections. Iterator design pattern 202, in this example, may include a pair of IEnumerable and IEnumerator interfaces, as embodied in the .NET framework.

As shown, at 206, the IEnumerable interface may be defined by a method called GetEnumerator( ), which has no parameters as input and returns an enumerator of type T. As shown, at 208, the IEnumerator interface may be defined to include a method called MoveNext, which has no parameters as input and returns a Boolean value. MoveNext causes the enumerator to point to a next item of a pull-based collection. If MoveNext completes successfully, then MoveNext may return a Boolean value of true. If MoveNext determines that there are no additional items of the pull-based collection, then MoveNext and may return a Boolean value of false. If an error occurs while performing MoveNext, an exception may occur. T Current {get;} causes a value of type T of a property of the enumerator, called Current, to be retrieved. In other words, a value of an item of a collection pointed to by the enumerator is retrieved. Thus, a protocol for obtaining items of a pull-based collection includes using the method MoveNext to cause an enumerator to point to a next item of the pull-based collection. A value of a property of the enumerator, called Current, may be obtained if MoveNext returns a Boolean value of true. The value of the property Current may be a value of the next item of the pull-based collection pointed to by the enumerator. The Current property could cause an exception when an error condition occurs. The exception may be an implicit return value, which becomes an explicit parameter of type Exception to a method for handling exceptions.

As shown, at 210, IDisposable may be defined as an interface including a method called Dispose. Dispose has no parameters and returns no values. The method Dispose provides an indication that a resource of an IDisposable interface may be released. At 208, the IEnumerator interface is defined as being disposable, as indicated by “interface IEnumerator <T>: IDisposable”. That is, when an enumerator will not be used again by a disposable IEnumerator interface, the Dispose message may be performed to indicate that the enumerator may be released and again be made available.

A protocol for pulling items of an enumerable, or pull-based, collection from a producer include calling the MoveNext method to point to a next item of the pull-based collection as long as a the MoveNext method returns a Boolean value of true, indicating an existence of the next item of the collection. Obtaining the Current property of the item pointed to by the enumerator obtains a value of the item of the collection. One the MoveNext method returns a Boolean value of false, the MoveNext method will continue to return the Boolean value of false when called, indicating an absence of additional items of the collection.

To obtain push-based or observable collections, signatures of all members of enumerable (pull-based) and enumerator APIs may be reversed to obtain a pair of dual interfaces. In some embodiments, only collection aspects of pull-based collections may be dualized. A resource management aspect, such as the IDisposable interface and the Dispose method, may be invariant between pull-based collections and push-based collections.

As previously described, with respect to the protocol for pull-based collections, once the MoveNext method has returned a Boolean value of false, MoveNext will continue to return the Boolean value false for each successive call. Thus, in an exemplary embodiment, a dual of MoveNext, shown in an exemplary IObserver interface 212 is a method called Abort, which may include a Boolean parameter as input and may not return any values. Instead of passing a Boolean parameter to the Abort method, calling of the Abort method may be optimized by encoding the Boolean parameter as true when the Abort method is called. By not calling the Abort method, the Boolean argument may be considered to be encoded as false.

A property, Notify, of IObserver interface 212, may be defined as a dual of the property Current of the IEnumerator interface. As shown in IObserver interface 212, T Notify {set;} may set a value of the Notify property to a value of type T, corresponding to a value of an item of a push-based collection. Similar to the Current property of IEnumerator interface 208, the Notify property may cause an exception when an error condition occurs. The exception may be an implicit return value, which becomes an explicit parameter of type Exception to a method called OnError for processing exceptions.

As shown, in an IObservable interface 214, IObservable interface 214 may define a disposable method, called Add, which is a dual of the GetEnumerator method. The GetEnumerator method has no parameters for input and returns an instance of an enumerator of type T, while the Add method is provided with an observer of an IObserver interface and returns no parameters. The Add method may associate an observer with the IObserver interface 212, such that the observer may be notified of one or more items of a push-based, or observable, collection when a Notify property of an IObservable interface is set.

The protocol for IObserver interface 212 includes calling the Abort method causing an iterator to point to a next item of a push-based collection and setting a Notify property of the iterator to indicate availability of the next item of the push-based collection. Thus, the protocol for push-based collections may be a dual of a protocol for pull-based collections.

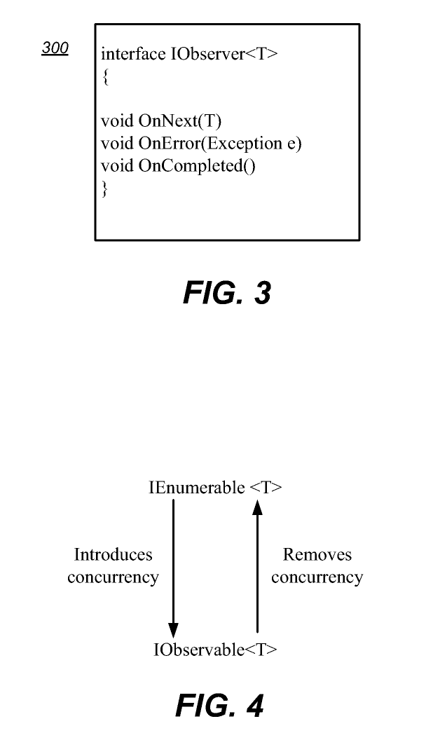

FIG. 3 illustrates an exemplary optimized IObserver interface 300 corresponding to IObserver interface 212. The Abort method of IObserver interface 212 may be replaced in IObserver interface 300 with a method called OnCompleted, which may be performed when an end of a push-based collection has been reached. The property Notify of IObserver interface 212 may be replaced in IObserver interface 300 with an OnNext method, which may obtain a value of a next item of the push-based collection. A method called OnError may be performed when an exception condition occurs while performing the OnNext method, as well as the OnCompleted method.

A protocol for IObserver interface 300 includes calling the OnNext method when a next item of a push-based observable collection is available. When no additional items are to be pushed to the push-based observable collection, the OnCompleted method may be called. Thus, after the OnCompleted method is called with respect to a push-based collection, the MoveNext method may not be called again for the push-based collection.

### Pull-Based and Push-Based Collections

Pull-based collections are time invariant. However, causality, or the order of items in the pull-based collections, is preserved by sequence operators for operating on pull-based collections. Sequence operators for operating on push-based collections introduces concurrency. FIG. 4 illustrates that a sequence operator for push-based collections, corresponding to a sequence operator for pull-based collections, introduces concurrency, while a sequence operator for pull-based collections, corresponding to a sequence operator for push-based collections, removes concurrency. For example, sequence operators for operating on push-based collections may produce an event stream in which some events occur concurrently. However, sequence operators for operating on pull-based collections cannot produce an event stream in which some events occur concurrently.

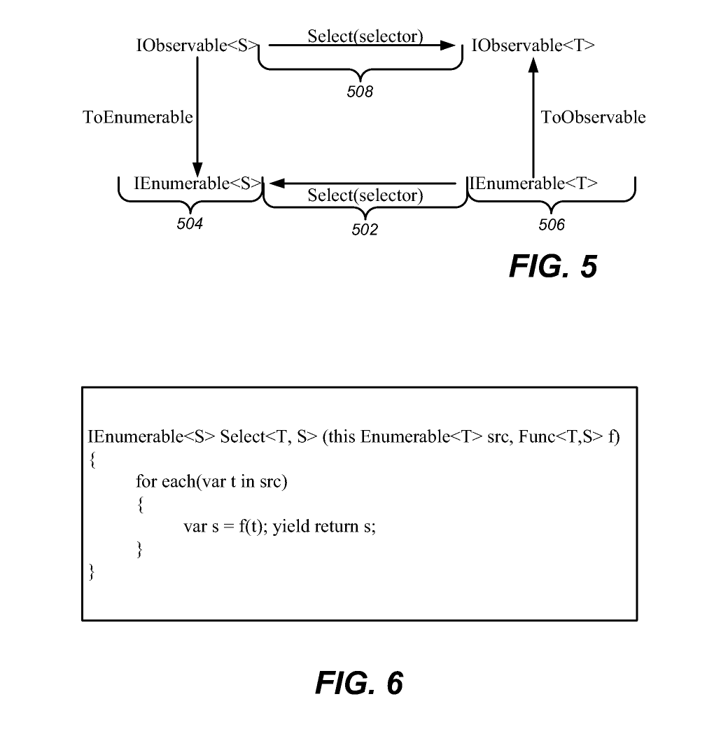

A Select operator may be applied to a pull-based collection. The Select operator may apply a function to each value of respective items in the pull-based collection to produce new values, which may be mapped to each of the respective items in the pull-based collection. FIG. 5 shows, at 502, the Select operator being applied to a pull-based collection. FIG. 5 also shows that a push-based collection may be converted to a pull-based collection, at 504, by calling a push-based, or push-based, operator. The select operator may be applied to values of respective items of the pull-based collection to produce new values, which may be mapped to each of the respective items in the pull-based collection, at 502, and the pull-based collection may be converted back to a push-based collection, at 506, by calling an enumerable, or pull-based, operator.

A Selector operator may be defined for push-based collections. The push-based Select operator may apply a function to each value of each event in the pull-based collection to produce a new value, which may be mapped to each of the respective events in the push-based collection, as shown at 508. In fact, the operation performed at 508 is equivalent to performing the operation at 504, 502, and then 506.

Further, a pull-based collection may be converted to a push-based collection, the push-based Select operator may apply a function to each value of each event and may map each of the respective values to each of the respective events of the push-based collection. The push-based collection may then be converted back to a pull-based collection. Such an operation is equivalent to the operation at 502 of FIG. 5

### The Select Operator

Because software developers typically have difficulty developing programs for asynchronous or push-based observable collections, implementing standard sequence operators, such as, for example, Select, or other standard sequence operators, for processing the push-based observable collections may be challenging. Fortunately, duality between push-based and pull-based collections makes this task easier. Further, semantics of push-based operators may be based on a relationship between push-based collections and pull-based collections.

To implement a standard sequence operator, such as Select, for push-based collections, let us first look at an implementation of Select for pull-based collections. For pull-based collections, Select applies a selector function “f” to each element of a source collection “src” to produce each subsequent value of a result. FIG. 6 illustrates exemplary code for implementing Select for pull-based collections. The code appears to be deceptively simple because the code relies on powerful syntactic sugar of foreach loops and yield return iterators, which a C# compiler expands into calls to GetEnumerator( ) and MoveNext( )/Current and a complex state-machine that maintains all control-flow and variable states across interruptions, respectively. Consequently, actual code is much more complex than as shown in FIG. 6.

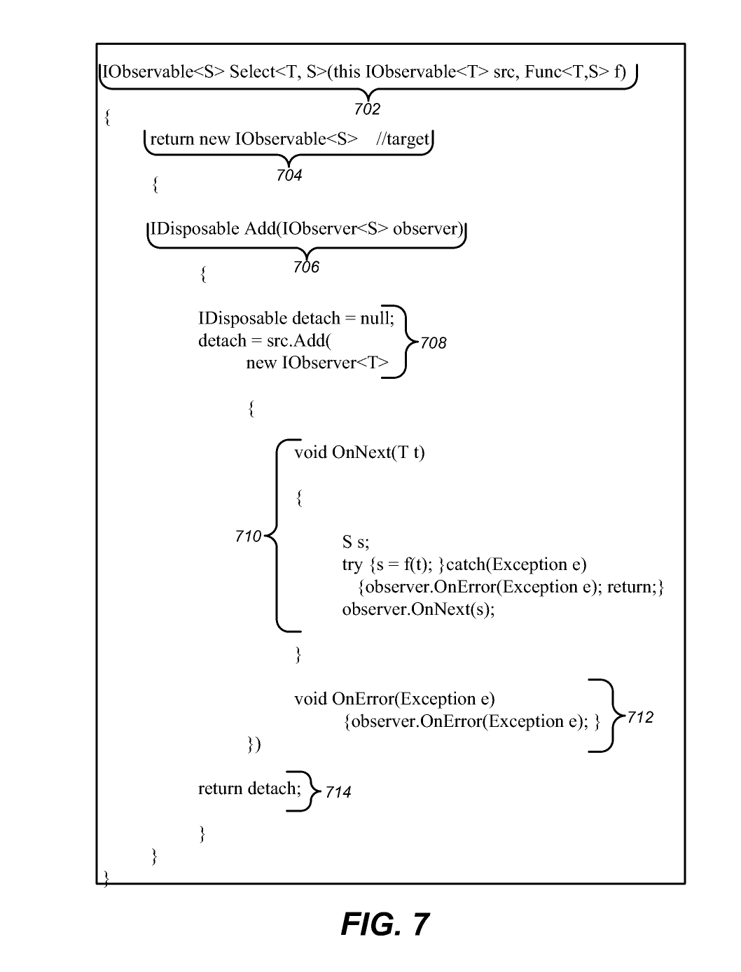

An implementation of a Select operator for push-based collections observes a source event stream, and whenever an observer is notified of a next value of an event, the observer applies the Select operator and then notifies the observer's observer that a resultant value is available. As can be seen at 702 in FIG. 7, the push-based Select standard sequence operator receives, as input parameters, a function “f”, which receives a value of type S and produces a value of type T. The function “f” is applied to values of respective events of an input IObservable interface to produce values of respective events to a new IObservable interface. As indicated at 704, a target of the Select standard sequence operator is an IObservable interface having one or more events of a type S.

At 706, an observer is associated with an IObserver interface, such that when one or more events of the IObserver interface become available, the observer may be notified of the one or more events. At 708, a disposable “detach” is set to null and a new observer is associated with a new IObserver interface.

At 710, an OnNext method is defined. The OnNext method may be performed when the new observer is notified of availability of an event. When the new observer is notified, the OnNext method obtains the value of an event of type T, runs a selector on the obtained value, and if successful, notifies the target observer of the transformed value of type S by calling the OnNext method. If, while applying the selector, an exception occurs, or an exception is signaled by a source, then the exception may be immediately thrown to the target observer by calling a method called OnError, which receives an input parameter of type Exception.

At 712, the OnError method for the new observer is defined to call the OnError method to notify a target observer.

At 714, the new observer is disassociated from the source when the source sends a Dispose message.

### Standard Sequence Operators

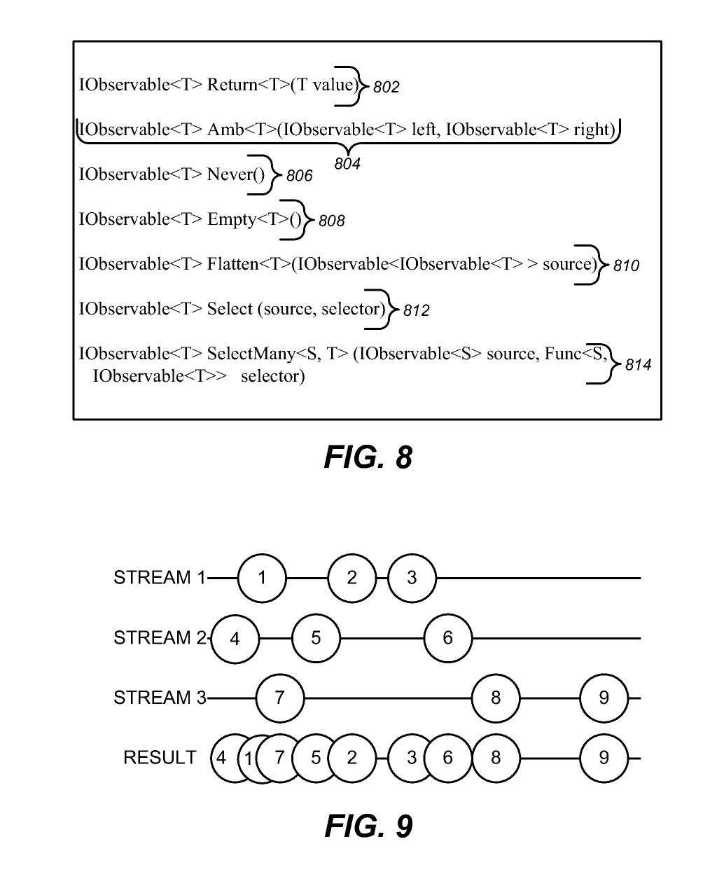

FIG. 8 illustrates exemplary standard sequence operators for push-based observable collections, which may be defined based on deriving duals of corresponding standard sequence operators for pull-based enumerable collections. The exemplary standard sequence operators for push-based observable collections may include Return 802, Amb 804, Never 806, Empty 808, Flatten 810, Select 812 and SelectMany 814.

Return 802 returns a single value of type T. Thus, for example, if Return is called with a parameter, which is a collection or event stream, then a single value of type T, corresponding to a value of an item of the collection or the event string, may be returned in some embodiments.

Amb 804 receives two observable push-based event streams, a left stream and a right stream, both of type T. After calling Amb 804, the event stream on which a first push-based event occurs is returned. For example, if, after calling Amb 804, the right stream experiences an event before the left stream, then Amb 804 may return events from the right stream. Similarly, if, after calling Amb 804, the left stream experiences an event before the right stream, then Amb 804 may return events from the left stream.

Never 806 receives no parameters, returns no parameters and never returns after being called.

Empty 808 has no input parameters and returns an empty push-based collection, or event stream, of type T.

Flatten 810 receives a push-based collection, or event stream, of type T and returns a push-based event stream of type T. Typically, at least some of the events of the event stream may be nested collections, or nested event streams. Flatten 810 produces an event stream having no nested event streams. For example, if an event stream includes events {1, 2, {3, 4, 5}, 6}, where {3, 4, 5} is a nested event stream, then Flatten 810 would produce {1, 2, 3, 4, 5, 6} from the event stream.

FIG. 9 helps to illustrate operation of Flatten 810. In this example, Flatten 810 receives, as input, an event stream having nested event streams of stream 1, stream 2 and a stream 3. Each circle represents an event. For example, nested stream 1 has events 1-3, nested stream 2 has events 4-6, and nested stream 3 has events 7-9. Flatten 810, in this embodiment, maps each event of the nested streams to a result stream, while preserving causality. That is, an order of events of each nested stream is preserved in the result stream. As can be seen in the result stream of FIG. 9, event 1 occurs before event 2, which occurs before event 3, as in event stream 1. Event 4 occurs before event 5, which occurs before event 6, as an event stream 2. Event 7 occurs before event 8, which occurs before event 9, as an event stream 3.

Select 812 receives an indication of a selector and a source. The selector may define a function to be performed on values of the source to produce a push-based of type T, as explained previously. If the source is an event stream, then a respective value of each event of the source event stream may have the function performed thereon to produce an event stream having events with values equal to a result of applying the function to the value of corresponding events of the source event stream.

SelectMany 814 receives, as input, a push-based source of type S, which could be an event stream, and a function that operates on values of type S to produce a push-based target of type T. If the source includes one or more nested event streams, SelectMany 814 may be capable of operating on events of the one or more nested event streams to produce a result stream having a corresponding one or more nested event streams.

The above-mentioned standard sequence operators may be combined in various ways to produce useful results. For example, the Flatten operator can be formed by combining the SelectMany operator with the Return operator. For example, the SelectMany operator may operate on an event stream, including nested event streams. The Return operator may be applied to each event of a resulting event stream, including events on any nested event streams, to produce a resulting flattenned event stream. Similarly, applying an Amb operator to a first push-based event stream and an empty push-based event stream, produced by the Empty operator, produces an output push-based event stream equal to the first push-based event stream.

In some embodiments, a Where operator may be defined to drop events from a source. The following is exemplary code for performing such an operation:

```
IObservable<T > Where(IObservable<T> source, Func<T, bool>
predicate)
{
  return SelectMany<T,T>(source, t=> predicate(t) ? Return<T>(t):
  Empty<T>( ));
}
```

The Where operator operates on a push-based source of type T, which may be an event stream. The Where operator is defined to perform a SelectMany operation on the IObservable source of type T by applying a predicate to values of respective events in the source. If applying the predicate to a value of an event of the source event stream produces a true Boolean value, then a value of type T may be returned. If applying the predicate to the value of the source event produces a false Boolean value, then an empty event stream may be returned. Thus, event streams having values of type T and empty collections may be produced. Any nested event streams may be flattened by application of the Return operator when the application of a predicate produces a true value. Effectively, when applying the predicate to a value of an event of an event string produces a false Boolean value, the value of the event of the event string is dropped from the produced output.

### Miscellaneous

The above-mentioned operators are only exemplary. In other embodiments consistent with the subject matter of this disclosure, operators may have different names, may have different types of inputs, may produce different types of outputs, and/or may perform different functions. Further, exemplary queries provided in this application are coded using LINQ. However, in other embodiments, the queries may be coded in XLINQ, C#, or other languages.

### CONCLUSION

Embodiments consistent with the subject matter of this disclosure provide a library of routines for implementing a number of standard sequence operators for processing asynchronous, push-based, observable collections. As a result, many of the difficulties that software developers currently experience when developing code for processing asynchronous, push-based, observable collections have been diminished or eliminated.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Other configurations of the described embodiments are part of the scope of this disclosure. For example, in other embodiments, an order of acts performed by a process may be performed in a different order, and/or may include additional or other acts.

Accordingly, the appended claims and their legal equivalents define embodiments, rather than any specific examples given.

We claim as our invention:

1. A method in a computing device for defining a push-based application program interface, the method comprising:
defining the push-based application program interface based on deriving duals of aspects of a pull-based application program interface, wherein
the method is implemented on the computing device.

2. The method of claim 1, wherein the defining of the push-based application program interface further comprises:
defining an subject/observer design pattern for push-based collections based on a dual of at least some aspects of an iterator design pattern for pull-based collections.

3. The method of claim 1, further comprising:
defining push-based standard sequence operators based on respective duals of corresponding pull-based standard sequence operators.

4. The method of claim 3, further comprising:
defining push-based operators based on the push-based standard sequence operators, wherein
semantics of the push-based operators are based on a relationship between push-based collections and pull-based collections.

5. The method of claim 1, wherein the defining of the push-based standard sequence operators introduces concurrency.

6. The method of claim 1, wherein the standard sequence operators comprise:
a first operator for returning a push-based collection with one value;
a second operator which does not produce a value;
a third operator that produces an empty push-based collection;
a selector operator that is applied to each value in an push-based collection; and
a fourth operator that flattens a plurality of push-based collections to produce a single push-based collection that preserves causality among a plurality of events of the plurality of push-based collections.

7. The method of claim 1, further comprising:
defining a protocol for a push-based collection as a dual of a protocol for a pull-based collection.

8. The method of claim 7, wherein the defining of a protocol for a push-based collection as a dual of a protocol for a pull-based collection further comprises:
optimizing the protocol for the push-based collection.

9. A computing device comprising:
at least one processor; and
a memory connected to the at least one processor, the memory further comprising:
instructions for providing a push-based application programming interface, the push-based application program interface having been defined based on deriving mathematical duals of aspects of a pull-based application program interface.

10. The computing device of claim 9, wherein:
the application programming interface comprises a library of routines,
and the library of routines includes a plurality of push-based standard sequence operators defined by deriving duals of corresponding pull-based standard sequence operators.

11. The computing device of claim 10, wherein the plurality of push-based standard sequence operators implement LINQ standard sequence operators.

12. The computing device of claim 10, wherein:
the library of routines includes a routine to convert a pull-based collection to a push-based collection, and
a sequence operator operating on the push-based collection introduces concurrency to a resulting push-based collection.

13. The computing device of claim 10, wherein the library of routines includes a plurality of push-based operators defined in terms of the plurality of push-based standard sequence operators.

14. The computing device of claim 13, wherein semantics of the push-based operators are based on a relationship between push-based collections and pull-based collections.

15. A tangible machine-readable medium having instructions recorded therein for at least one processor of a computing device to perform a method, the method comprising:
defining a push-based application program interface based on deriving a dual of a pull-based application program interface, the application program interface including a plurality of routines within a library, the plurality of routines including a plurality of push-based operators, wherein
the method is performed on a computing device.

16. The tangible machine-readable medium of claim 15, wherein:
a first one of the push-based operators converts a pull-based collection to a push-based collection, and
a second one of the push-based operators introduces concurrency to the push-based collection.

17. The tangible machine-readable medium of claim 15, wherein the method further comprises:
defining a first protocol for processing push-based collections, the defined protocol being a dual of a second protocol for processing pull-based collections.

18. The tangible machine-readable medium of claim 15, wherein the plurality of push-based operators are comprised of a plurality of push-based standard sequence operators.

19. The tangible machine-readable medium of claim 18, wherein the plurality of push-based standard sequence operators are based on deriving respective duals of corresponding pull-based standard sequence operators.

20. The tangible machine-readable medium of claim 18, wherein the plurality of push-based standard sequence operators comprise at least 3 operators selected from a group consisting of:
a first operator that returns a push-based collection with one value;
a second operator that does not return after being called;
a third operator that returns an empty push-based collection;
a fourth operator that applies a function to each value in a push-based collection; and
a fifth operator that flattens a plurality of push-based collections to produce a single push-based collection.
